(19) United States
(12) Patent Application Publication
(10) Pub. No.: US 2026/0072382 A1
(43) Pub. Date: Mar. 12, 2026

(54) IMAGE HEATING APPARATUS AND IMAGE FORMING APPARATUS

(71) Applicant: CANON KABUSHIKI KAISHA, Tokyo (JP)

(72) Inventor: KENTA OGASAWARA, Shizuoka (JP)

(21) Appl. No.: 19/317,299

(22) Filed: Sep. 3, 2025

(30) Foreign Application Priority Data
Sep. 9, 2024 (JP) 2024-155380

(51) Int. Cl. G03G 15/20; H05B 6/14

(52) U.S. Cl. CPC G03G 15/2039; G03G 15/2053; G03G 15/2064; H05B 6/145

(57) ABSTRACT

An image heating apparatus includes a tubular rotary member, a magnetic core, an exciting coil, an inverter, at least one temperature detecting portion configured to detect a temperature of the rotary member, and a storage configured to store a reference value of a variation amount per unit time of a detected temperature. The control portion is configured to change a driving frequency of the inverter. The control portion is configured to change a driving frequency of the inverter, acquire the variation amount per unit time of the detected temperature detected by the temperature detecting portion, correct the reference value based on the drive frequency of the inverter at the time when the variation amount is acquired, and stop heating of the rotary member in a case where the variation amount is smaller than the reference value being corrected.

### BACKGROUND

### Field of the Technology

The present disclosure relates to an image heating apparatus and an image forming apparatus that heats images formed on recording materials.

### Description of the Related Art

Hitherto, an electromagnetic induction heating type fixing apparatus that heats a heat generating layer, i.e., conductive layer, disposed on a heating rotary member directly through electromagnetic induction has been proposed. According to this apparatus, an exciting coil and a magnetic core are arranged in an interior of a cylindrical heating rotary member, and an alternating magnetic field is generated in a rotation axis direction of the heating rotary member, wherein heat is generated in the heat generating layer by a current that is flown in a circumferential direction of the heating rotary member, i.e., circumferential circuit (refer to Japanese Patent Application Laid-Open Publication No. 2020-52308).

According further to the electromagnetic induction heating type apparatus as described above, it is known that a generated heat distribution in a longitudinal direction of the heating rotary member may be controlled by varying a drive frequency of a high frequency current supplied to the exciting coil (refer to Japanese Patent Application Laid-Open Publication No. 2020-52233).

Since the generated heat distribution of the heating rotary member in the electromagnetic induction heating type apparatus varies according to drive frequency, a detected temperature of a temperature detecting element that monitors the temperature of the heating rotary member also varies according to the drive frequency. Meanwhile, the detected temperature of the temperature detecting element may also be varied due to unexpected causes, such as a failure of the temperature detecting element itself, or a poor contact formed between the temperature detecting element and a target area in the case of a contact-type temperature detecting element. Therefore, it is difficult to determine whether the variation of detected temperature of the temperature detecting element is a normal result due to the variation of drive frequency or is an abnormal result caused by malfunction of the element.

Further, abnormality of detected temperature of the temperature detecting element may lead to erroneous operation or temperature control failure, such that it is desirable to determine whether the detected temperature is abnormal or normal, and to perform appropriate control based thereon.

### SUMMARY

According to a first aspect of the present disclosure, an image heating apparatus configured to heat an image formed on a recording material, includes a tubular rotary member including a conductive layer, a magnetic core disposed in an interior of the rotary member and configured to form an open magnetic path in a longitudinal direction of the rotary member, an exciting coil wound around the magnetic core such that a helical axis thereof is arranged along the longitudinal direction, an inverter configured to flow alternating current in the exciting coil, an inverter configured to flow alternating current in the exciting coil, at least one temperature detecting portion configured to detect a temperature of the rotary member, and a storage configured to store a reference value of a variation amount per unit time of a detected temperature detected by the temperature detecting portion. The control portion is configured to change a driving frequency of the inverter. The control portion is configured to change a driving frequency of the inverter, acquire the variation amount per unit time of the detected temperature detected by the temperature detecting portion, correct the reference value based on the drive frequency of the inverter at the time when the variation amount is acquired, and stop heating of the rotary member in a case where the variation amount is smaller than the reference value being corrected.

According to a second aspect of the present disclosure, an image heating apparatus configured to heat an image formed on a recording material, includes a tubular rotary member including a conductive layer, a magnetic core disposed in an interior of the rotary member and configured to form an open magnetic path in a longitudinal direction of the rotary member, an exciting coil wound around the magnetic core such that a helical axis thereof is arranged along the longitudinal direction, an inverter configured to flow alternating current in the exciting coil, a control portion configured to control the inverter to cause alternating current to flow through the exciting coil such that alternating magnetic flux is generated in the magnetic core to heat the rotary member by electromagnetic induction, and a first temperature detecting portion configured to detect a temperature of the rotary member at a center portion in the longitudinal direction of the rotary member. When a drive frequency of the inverter is a first drive frequency, the control portion is configured to stop heating of the rotary member in a case where a variation amount per unit time of a detected temperature of the first temperature detecting portion is smaller than a first value. When a drive frequency of the inverter is a second drive frequency that is greater than the first drive frequency, the control portion is configured to stop heating of the rotary member in a case where a variation amount per unit time of the detected temperature of the first temperature detecting portion is smaller than a second value that is smaller than the first value.

According to a third aspect of the present disclosure, an image heating apparatus configured to heat an image formed on a recording material, includes a tubular rotary member including a conductive layer, a magnetic core disposed in an interior of the rotary member and configured to form an open magnetic path in a longitudinal direction of the rotary member, an exciting coil wound around the magnetic core such that a helical axis thereof corresponds to the longitudinal direction, an inverter configured to flow alternating current in the exciting coil, a control portion configured to control the inverter to cause alternating current to flow through the exciting coil such that alternating magnetic flux is generated in the magnetic core to heat the rotary member by electromagnetic induction, a first temperature detecting portion configured to detect a temperature of the rotary member at a first position in the longitudinal direction of the rotary member, and a second temperature detecting portion configured to detect a temperature of the rotary member at a second position that differs from the first position in the longitudinal direction. When a drive frequency of the inverter is a first drive frequency, the control portion is configured to stop heating of the rotary member in a case where a variation amount per unit time of a detected temperature of the first temperature detecting portion is smaller than a fifth value corresponding to the first drive frequency, or in a case where a variation amount per unit time of a detected temperature of the second temperature detecting portion is smaller than a sixth value obtained based on the fifth value and an information related to correlation of the detected temperature of the first temperature detecting portion and the detected temperature of the second temperature detecting portion. When a drive frequency of the inverter is a second drive frequency that differs from the first drive frequency, the control portion is configured to stop heating of the rotary member in a case where a variation amount per unit time of the detected temperature of the first temperature detecting portion is smaller than a seventh value corresponding to the second drive frequency, or in a case where a variation amount per unit time of the detected temperature of the second temperature detecting portion is smaller than an eighth value obtained based on the seventh value and an information related to correlation of the detected temperature of the first temperature detecting portion and the detected temperature of the second temperature detecting portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view of an image forming apparatus according to a first embodiment.

FIG. 2 is a schematic cross-sectional side view of a fixing apparatus according to the first embodiment.

FIG. 3 is a schematic front view of the fixing apparatus according to the first embodiment.

FIG. 4 is a perspective projection drawing and a connection circuit block diagram of the fixing apparatus according to the first embodiment.

FIG. 5 is view illustrating a relationship between an exciting coil current and a magnetic field according to the first embodiment.

FIG. 6 is a physical model drawing related to an induced current flowing in a fixing film according to the first embodiment.

FIG. 7A is a view illustrating an equivalent circuit of the exciting coil and a heat generating layer of the fixing film.

FIG. 7B is a view illustrating an equivalent circuit of the exciting coil and a heat generating layer of the fixing film.

FIG. 7C is a view illustrating an equivalent circuit of the exciting coil and a heat generating layer of the fixing film.

FIG. 8A is a view illustrating the equivalent circuit of the exciting coil and the heat generating layer of the fixing film.

FIG. 8B is a view illustrating the equivalent circuit of the exciting coil and the heat generating layer of the fixing film.

FIG. 9 is an image view of a phenomenon in which an apparent magnetic permeability is lower at end portions than at a center portion.

FIG. 10 is a view illustrating lines of magnetic force in a state where a ferrite is arranged in a uniform magnetic field H.

FIG. 11 is a view illustrating a generated heat distribution in a longitudinal direction of the fixing film according to the first embodiment.

FIG. 12 is a view illustrating the generated heat distribution in the longitudinal direction of the fixing film according to the first embodiment.

FIG. 13 is a schematic view of temperature transition of the fixing film according to the first embodiment.

FIG. 14 is a view illustrating the generated heat distribution in the longitudinal direction of the fixing film within section C.

FIG. 15 is a schematic view illustrating a detected temperature transition of the temperature detecting element within section C according to the first embodiment.

FIG. 16 is a flowchart illustrating a driving sequence of the fixing apparatus according to the first embodiment.

FIG. 17 is a schematic view illustrating a detected temperature transition of a temperature detecting element according to a second embodiment.

FIG. 18A is a schematic view illustrating a detected temperature transition of a temperature detecting element within section C according to a third embodiment.

FIG. 18B is a graph illustrating a transition of detected temperature in section C of a temperature detecting element arranged at a center portion and a temperature detecting element arranged at an end portion in the longitudinal direction of the fixing film 1.

### DESCRIPTION OF THE EMBODIMENTS

### First Embodiment

### Configuration of Image Forming Apparatus

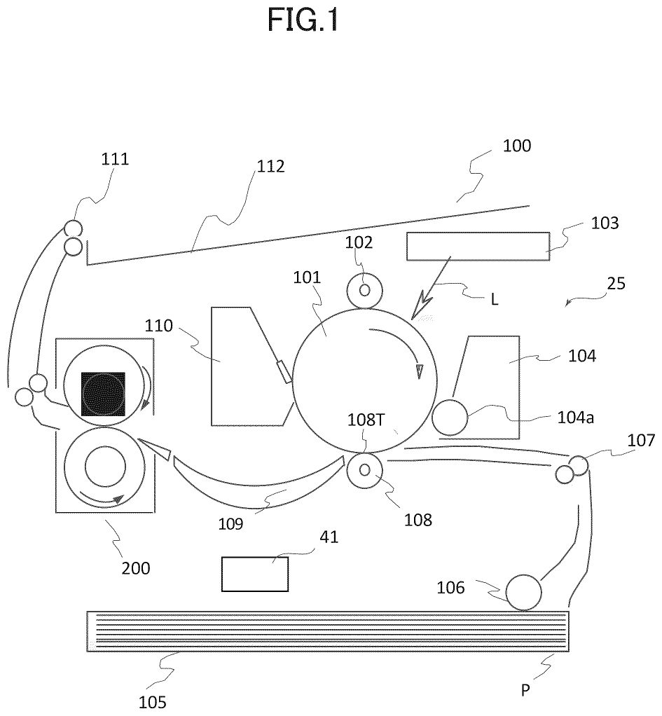

A fixing apparatus that serves as an image heating apparatus according to an embodiment of the present disclosure and an image forming apparatus 100 equipped with the same will be described below with reference to the drawings. As illustrated in FIG. 1, the image forming apparatus 100 is an electrophotographic laser beam printer, and includes a sheet feed cassette 105, a feed roller 106, a registration roller 107, an image forming unit 120, a fixing apparatus 200, and a controller 41. The sheet feed cassette 105 is a recording material supporting unit that supports a recording material P in a stacked manner, and supports and accommodates the recording material P therein. The feed roller 106 is a feeding unit that feeds the recording material P stored in the sheet feed cassette 105, and separates and feeds the recording materials P stacked and accommodated in the sheet feed cassette 105 one by one. The registration roller 107 is a recording material conveyance unit that conveys the recording material fed from the sheet feed cassette 105 toward an image forming unit 25, and conveys the recording material P at a matched timing with the forming of image at the image forming unit 25.

The image forming unit 25 forms an image on the recording material P, and includes a photosensitive drum 101, a charge roller 102, an exposing unit 103, a developing unit 104, a transfer roller 108, and a cleaning unit 110. The photosensitive drum 101, the charge roller 102, the exposing unit 103, the developing unit 104, the transfer roller 108, and the cleaning unit 110 are disposed around the photosensitive drum 101, and the charge roller 102 charges the photosensitive drum 101 that is rotated at a predetermined speed in an arrow direction in the drawing to uniform polarity and potential. The exposing unit 103 is a laser beam scanner that outputs a laser light that is on-off modulated in accordance with a time-series electric digital pixel signal of the target image information sent from an external apparatus such as a host computer, and scans and exposes, i.e., irradiates, a charged processing surface of the photosensitive drum 101. The developing unit 104 includes a developing roller 104a that supplies a developer, i.e., toner, to the surface of the exposing unit 103, and develops the electrostatic latent image formed on the surface of the photosensitive drum 101 by the exposing unit 103 using the developer. The transfer roller 108 together with the photosensitive drum 101 forms a transfer nip 108T for transferring image at a transfer portion, and by having a transfer voltage applied to the transfer roller 108, a toner image formed on the photosensitive drum 101 is transferred onto the recording material P. The cleaning unit 110 is disposed downstream of the transfer nip 108T in the rotating direction of the photosensitive drum 101, and removes transfer residual toner and paper dust from the surface of the photosensitive drum 101.

The fixing apparatus 200 is an image heating apparatus that adopts an electromagnetic induction heating system, and includes a fixing film 1 that serves as a heating rotary member, and a pressing roller 8 that forms a fixing nip N together with the fixing film 1. The fixing apparatus 200, in which the fixing film 1 and the pressing roller 8 form the fixing nip N, fixes an unfixed toner image transferred onto the recording material P by supplying heat and pressure at the fixing nip N, by which the image is fixed to the recording material P.

The controller 41 is a controller that controls the respective units of the image forming apparatus 100 described above, and includes a ROM and a RAM that serve as a storage portion, a central processing unit (CPU) that serves as a computing unit, and various input/output control circuits (not shown).

In the image forming apparatus 100 configured as described above, if a feeding start signal is sent from the controller 41 to the feed roller 106, the feed roller 106 is driven and the recording material P in the sheet feed cassette 105 is separated and fed one by one. When the recording material P is fed from the sheet feed cassette 105, the recording material P is conveyed by the registration roller 107 to the transfer nip 108T at a matched timing with the conveyance of toner image on the photosensitive drum 101 to the transfer nip 108T. Then, the toner image is transferred onto the recording material P at the transfer nip 108T by applying a transfer voltage, i.e., transfer bias, whose polarity is opposite to the polarity of toner, to the transfer roller 108.

After the toner image is transferred to the recording material P, the recording material P that bears the unfixed toner image is conveyed by a pre-fixing conveyance guide 109 to the fixing apparatus 200, and the toner image is pressed and heated at the fixing apparatus 200 and thereby fixed to the recording material P. The recording material P to which the toner image has been fixed is discharged through a sheet discharge port 111 onto a sheet discharge tray 112 that serves as a discharge portion.

### Configuration of Fixing Apparatus

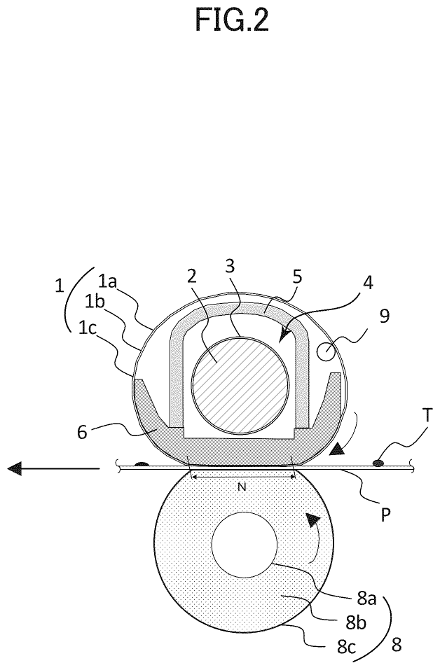

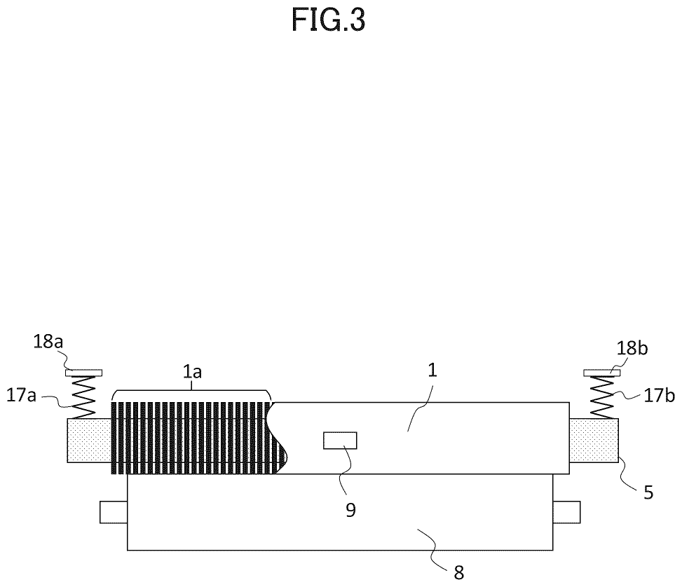

Next, a configuration of the fixing apparatus 200 will be described with reference to FIGS. 2 and 3. FIG. 2 is a schematic cross-sectional side view of a relevant portion of the fixing apparatus 200 according to the present embodiment, and FIG. 3 is a schematic front view of the fixing apparatus 200. In FIG. 3, a portion of the fixing film 1 in a longitudinal direction is illustrated in exploded view showing an internal structure thereof to illustrate a layer structure. In addition, according to the present embodiment, a temperature detecting element 9 that serves as a temperature detecting portion for detecting a temperature of the fixing film 1 is disposed in an interior of a rotary member 1, whereas in FIG. 3, the temperature detecting element 9 is illustrated outside the rotary member 1 to provide better visibility. Further, regarding the members constituting the fixing apparatus 200, the longitudinal direction refers to a direction orthogonal to a conveyance direction of the recording material, and the longitudinal direction corresponds to a width direction of the recording material.

According to the present embodiment, the fixing apparatus 200 is an electromagnetic induction heating-type image heating apparatus. As illustrated in FIG. 2, the fixing apparatus 200 includes the fixing film 1 that serves as a heat generation rotary member, and the pressing roller 8 that serves as a pressurizing rotary member, wherein the fixing nip N that presses and heats the recording material P is formed between the fixing film 1 and the pressing roller 8. Further, a film guide member 6, a pressurizing rigid stay 5, and a core unit 4 are disposed on the inner side of the fixing film 1. The film guide member 6 is formed of a polyphenylene sulfide (PPS) resin that has a heat-resisting property, and is pressed downward via the pressurizing rigid stay 5. Further, a sliding member is disposed on a lower surface of the film guide member 6, and the sliding member determines the shape of the fixing nip N.

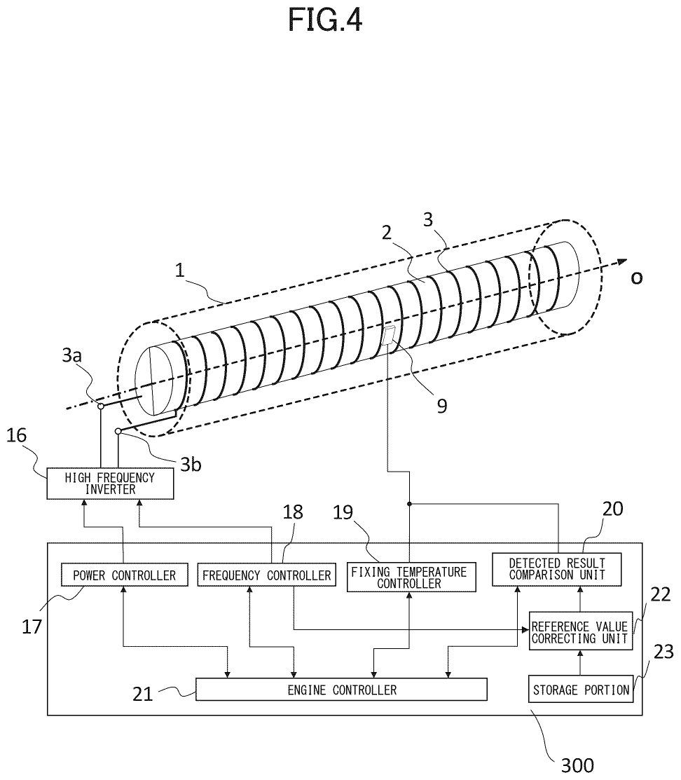

The core unit 4 has an exciting coil 3 wound around a circumference of a magnetic core 2 that serves as a magnetic core such that a helical axis is arranged along the longitudinal direction of the fixing film 1 (refer to FIG. 4), and the magnetic core 2 and the exciting coil 3 are inserted to the interior of the fixing film 1 between the film guide member 6 and the pressurizing rigid stay 5. The magnetic core 2 and the exciting coil 3 that is wound around the magnetic core 2 along an outer circumferential direction serve as a magnetic field generating unit that generates an alternating magnetic flux, i.e., alternating magnetic field, according to an AC power supplied from a high frequency inverter 16, and causes an induced current to be generated in a heat generating layer 1a of the rotary member. In the drawing, the exciting coil 3 is illustrated as a single conducting wire, but the present technique may include a plurality of conducting wires that are bundled as one wire.

The pressing roller 8 is arranged to face the film guide member 6 interposing the fixing film 1, and by being in pressure contact with the film guide member 6, the pressing roller forms the fixing nip N having a predetermined width between the pressing roller and the fixing film 1. Further, the pressing roller 8 is rotated in a counterclockwise direction by a driving unit not shown, and the fixing film 1 is driven to rotate by frictional force between the pressing roller 8.

FIG. 3 is a schematic front view of the fixing apparatus 200. As illustrated in FIG. 3, pressurizing springs 17a and 17b are arranged between both end portions of the pressurizing rigid stay 5 and spring receiving members 18a and 18b disposed on a chassis of the fixing apparatus 200, and the film guide member 6 is urged downward by urging force applied from the pressurizing springs 17a and 17b. Further, fixing film flanges not shown are disposed at both end portions of the fixing film 1, and the fixing film flanges regulate a rotation trajectory of the fixing film 1 together with the film guide member 6. In the present embodiment, the film guide member 6 is pushed down by a pressing force with a total pressure of approximately 100 to 250 N, i.e., approximately 10 to 25 kgf.

Further, the temperature detecting element 9 is disposed at a center portion in the longitudinal direction of the fixing film 1, and the temperature detecting element 9 serves as a temperature detecting portion that detects a surface temperature of the fixing film 1. Signals from the temperature detecting element 9 are entered to a control portion 300 illustrated in FIG. 4, and the control portion 300 is configured to control the high frequency inverter 16 based on the temperature detected by the temperature detecting element 9. In the present embodiment, the temperature of the fixing film 1 may be detected using any method, regardless of whether it is detected in a contact manner or in a noncontact manner.

The high frequency inverter 16 feeds a switching current of a frequency and amplitude based on a control signal of the control portion 300 via feed contacts 3a and 3b not shown to the exciting coil 3. Thereby, the heat generating layer 1a (refer to FIG. 2) of the fixing film 1 is heated by electromagnetic induction, such that the surface temperature is controlled to a predetermined target temperature.

According to the present embodiment, the fixing film 1 is a tubular rotary member having a composite structure with a diameter of 10 to 50 mm and that is composed of the heat generating layer 1a formed of a conductive member and that serves as a base layer, an clastic layer 1b laminated on an outer surface thereof, and a release layer 1c laminated on an outer surface thereof. The heat generating layer 1a serving as a conductive layer through which alternating current flows is formed of ring-shape heat generating patterns divided in the longitudinal direction of the rotary member 1, as illustrated in FIG. 3, wherein the heat generating pattern is formed of metal and has a thickness of 10 to 50 μm. Further, the elastic layer 1b is made of silicon rubber having a hardness of 20 degrees (JIS-A, load of 1 kg) and a thickness of 0.3 to 0.1 mm. The surface layer 1c, i.e., release layer, is a fluororesin tube having a thickness of 50 to 10 μm. In a state where an alternating magnetic flux is applied, an induced current is produced in the heat generating layer 1a and heat is generated. The generated heat is transmitted to the elastic layer 1b and the release layer 1c, by which the entire fixing film 1 is heated, and in a state where the recording material P is passed through the fixing nip N, a toner image T on the recording material P is heated and fixed.

Further, the pressing roller 8 includes a core metal 8a, an elastic material layer 8b that has a heat-resisting property and that is molded and coated in a roller-like shape coaxially and integrally about the core metal 8a, and a release layer 8c that serves as a roller surface layer. The release layer 8c is preferably formed of a material having a good heat-resisting property, such as silicon rubber, fluororubber, fluorosilicone rubber, and fluororesin.

### Heating Principle

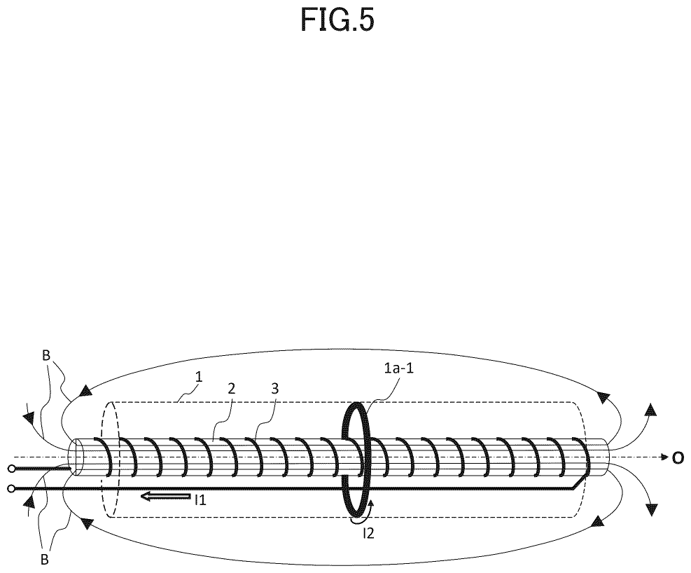

Next, a heating principle of the fixing film 1 will be described in detail. FIG. 5 is a conceptual diagram of a magnetic field around the magnetic core 2 and an induced current induced by the heat generating layer 1a. The magnetic core 2 forms a passage of lines of magnetic force, i.e., magnetic path, in an axial direction O of the fixing film 1, i.e., longitudinal direction of the fixing film 1 and the magnetic core 2. More specifically, the magnetic core 2 forms an open magnetic path in the longitudinal direction. When current is increasing in a direction of an arrow I1 in the exciting coil 3, the magnetic core 2 induces the line of magnetic force illustrated by a dotted line B in the drawing. This variation of magnetic field causes an induced current I2 to flow through the heat generating layer 1a of the rotary member 1, by which Joule heat is generated in the heat generating layer 1a.

A heat generating layer 1a-1 is one of the plurality of heat generating patterns being arranged, which is illustrated for description. The heating principle of the heat generating layer 1a-1 follows Faraday's law. An induced electromotive force V for supplying current in the circuit of the heat generating layer 1a-1 is proportional to a time variation of magnetic flux that passes perpendicularly through the circuit. The induced electromotive force V may be expressed in an equation as according to the following equation (1). The induced electromotive force V is proportional to a product of a variation ΔΦ/Δt of magnetic flux that passes perpendicularly through the heat generating layer 1a-1 in a minute time Δt and a number of turns N.

Equation 1

$$V = - N \cdot \frac{Δ Φ}{Δ t} \qquad ( 1 )$$

V: Induced electromotive force
N: Number of turns of coil
ΔΦ/Δt: Variation of magnetic flux passing perpendicularly through circuit in minute time Δt

In a state where the heat generating layer 1a-1 is connected in the circumferential direction, current flows by the above-described induced electromotive force V, and Joule heating occurs. Meanwhile, if the heat generating layer 1a-1 is not connected in the circumferential direction, current will not flow and Joule heating will not occur.

### Frequency Control of Generated Heat Distribution in Longitudinal Direction of Fixing Film

The electromagnetic induction heating-type fixing apparatus 200 can control the generated heat distribution in the longitudinal direction of the fixing film 1 by changing the drive frequency of the high frequency inverter 16 by the control portion 300. A principle based on which the generated heat distribution of the fixing film 1 changes by varying the drive frequency will be described below. Specifically, this principle is related to a frequency dependency of load resistance of the fixing film 1 and a magnetic flux density in the open magnetic path, such that these items are described sequentially.

### Frequency Dependency of Load Resistance of Rotary Member 1

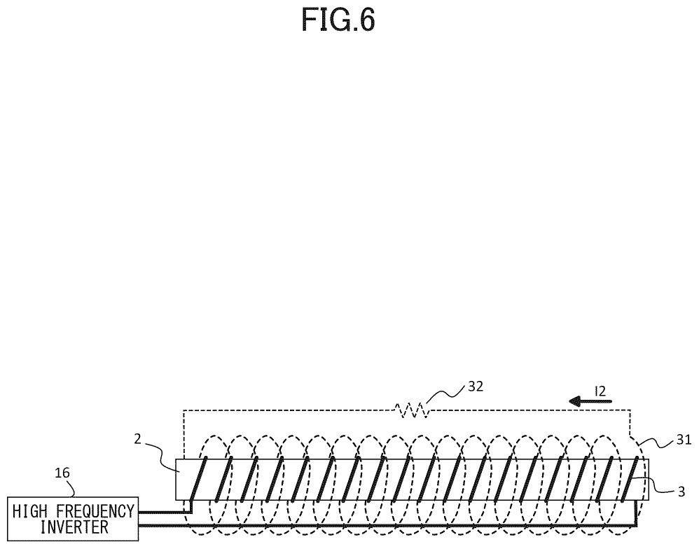

FIG. 6 illustrates a physical model regarding the induced current I2. This can be expressed as being of equal value with a magnetic coupling of a concentric transformer in which a primary winding coil, i.e., exciting coil, 3 illustrated by a solid line and a secondary winding coil 31 illustrated by a broken line are wound. Further, the secondary winding coil 31 forms a circuit, and includes a resistor 32. A high frequency current is generated in the primary winding coil 3 by alternating voltage produced in the high frequency inverter 16, and as a result, induced electromotive force is produced in the secondary winding coil 31, which is consumed as heat by the resistor 32. The secondary winding coil 31 and the resistor 32 model the Joule heat produced in the heat generating layer 1a.

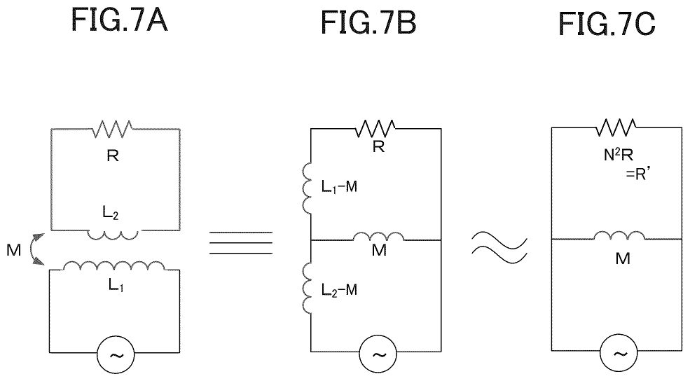

Next, an equivalent circuit of a model diagram illustrated in FIG. 6 is illustrated in FIG. 7A. In FIG. 7A, L1 denotes an inductance of the primary winding coil 3 (refer to FIG. 6), L2 denotes an inductance of the secondary winding coil 31 (refer to FIG. 6), M denotes a mutual inductance of the primary winding coil 3 and the secondary winding coil 31, and R denotes the resistor 32 (refer to FIG. 6). The circuit diagram illustrated in FIG. 7A can be equivalently transformed to FIG. 7B. Further, in order to consider a more simplified model, if the mutual inductance is sufficiently great, and if L1≈L2≈M, then (L1−M) and (L2−M) will be sufficiently small, and the circuit diagram can be approximated from FIG. 7B to FIG. 7C. Therefore, the configurations of the fixing film 1, the magnetic core 2, and the exciting coil 3 according to the present embodiment can be replaced with the equivalent circuit model illustrated in FIG. 7C and considered.

The resistance will be described below. In FIG. 7A, a secondary side impedance will be an electric resistance R in the circumferential direction of the heat generating layer 1a. Further, the secondary side impedance in the transformer will be an equivalent resistance R′=N²R which is N² times when viewed from the primary side, wherein N is a ratio of number of turns of the transformer. In a state where the number of turns of the exciting coil 3 according to the present embodiment is referred to as n, the ratio of number of turns of the transformer may be considered to be, when assuming that the number of turns of the heat generating layer 1a is one, the ratio of the number of turns of the transformer N=n. Therefore, it is possible to consider that R′=N²R=n²R, such that the equivalent resistance R′ illustrated in FIG. 7C increases as the number of turns of the exciting coil 3 increases.

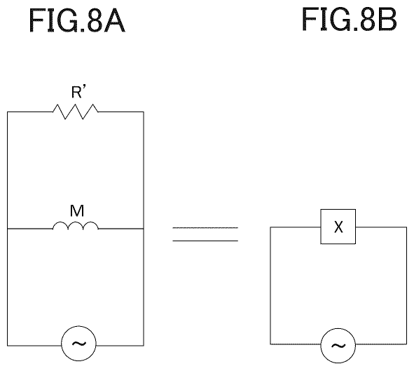

Next, FIG. 8A illustrates a model having further simplified the model of FIG. 7C. FIG. 8B defines a combined impedance X, which is a model having further simplified the model of FIG. 8A. A following equation (2) may be obtained by calculating the combined impedance X.

Equation 2

$$\frac{1}{X} = \frac{1}{{R}^{′}} + \frac{1}{j ω M} , ( ω = 2 π f ) \vert X \vert = \frac{1}{\sqrt{{( \frac{1}{{R}^{′}} )}^{2} + {( \frac{1}{ω M} )}^{2}}} \qquad ( 2 )$$

f: Frequency of current supplied from high frequency inverter 16

According to equation (2), the combined impedance X has a frequency dependency of (1/ωM)². This means that not only resistance R′ but also inductance M contributes to the combined impedance, and since the dimension of impedance is [Ω], it has the same meaning as stating that the load resistance of the rotary member 1 has a frequency dependency.

### Magnetic Flux Density in Open Magnetic Path

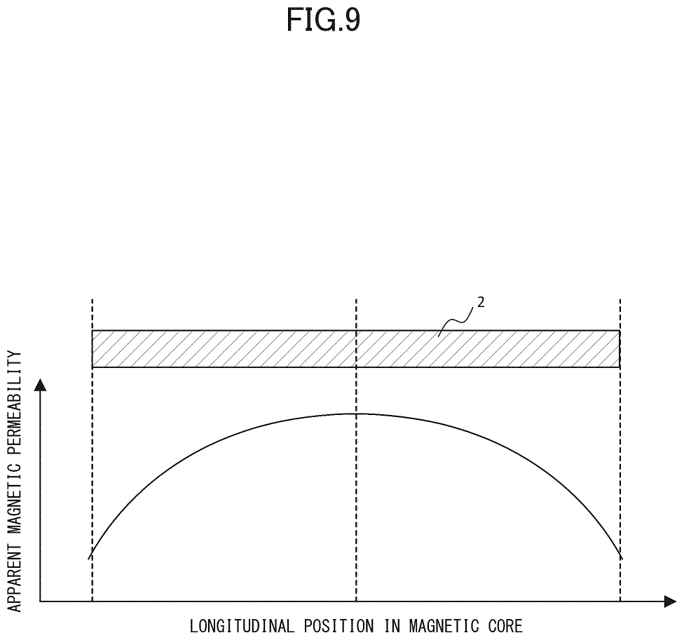

As illustrated in an image view in FIG. 9, according to the present embodiment, in a state where the magnetic core 2 and the exciting coil 3 are configured to form a magnetic path serving as an open magnetic path, an effect that “an apparent magnetic permeability u becomes small at end portions of the magnetic core” is obtained. This effect is described in detail below.

In a magnetic field area within a uniform magnetic filed H in which a magnetization of an object is approximately proportional to an external magnetic field, a magnetic flux density B in a space is calculated according to a following equation (3).

Equation (3)

B=μH. (3)

That is, when a substance having a high magnetic permeability μ is placed in the magnetic field H, ideally, the magnetic flux density B having a height proportional to the height of the magnetic permeability can be created. According to the present embodiment, this space having the high magnetic flux density is utilized as a “magnetic path”. Specifically, when a magnetic path is produced, there are a closed magnetic path which is created by connecting the magnetic path itself into a loop and an open magnetic path which is created by disconnecting the magnetic path by forming an open end, wherein the present embodiment characterizes in producing the open magnetic path.

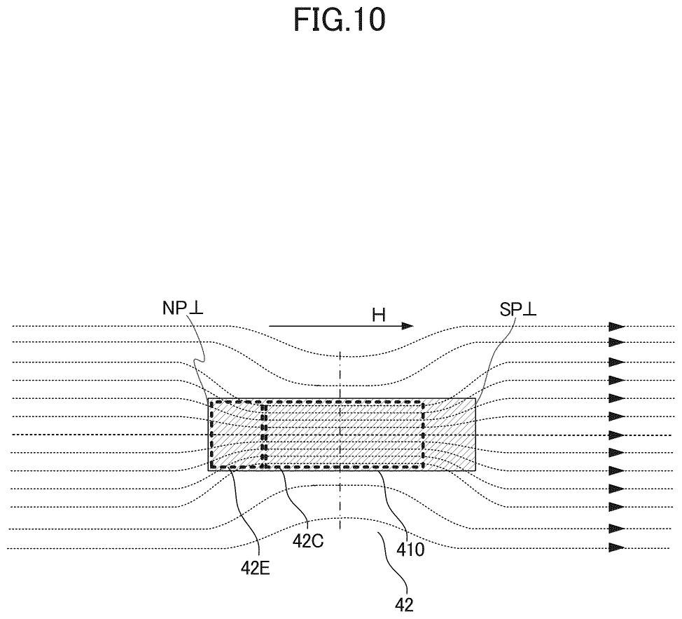

FIG. 10 illustrates a shape of a magnetic flux in a state where a ferrite 410 and air 42 are placed within a uniform magnetic field H. Ferrite has an open magnetic path that includes boundary surfaces NP^{⊥} and SP^{⊥} perpendicular to the lines of magnetic force with respect to air. In a state where the magnetic field H is produced in parallel with the longitudinal direction of the magnetic core, the lines of magnetic force have a thin density, that is, the magnetic flux density B is low in air, as illustrated in FIG. 10. Further, the density of the lines of magnetic force is dense, that is, the magnetic flux density B is high, at a center portion 41C of the magnetic core. Further, the magnetic flux density B is lower at end portions 41E compared to the center portion 41C of the magnetic core.

The magnetic flux density B becomes lower at the end portions due to a boundary condition of air and ferrite. In the boundary surfaces NP^{⊥} and SP^{⊥} perpendicular to the lines of magnetic force, the magnetic flux density is continuous, such that in the area near the boundary surface, the magnetic flux density becomes high at the portion where air is in contact with ferrite. In the ferrite end portions 41E that are in contact with air, the magnetic flux density becomes low. According to the present phenomenon, the magnetic flux density becomes small and the magnetic permeability at the end portions seems to be low, such that in the present embodiment, it is described that “the apparent magnetic permeability becomes small at the end portions of the magnetic core”.

The above-described phenomenon does not occur in the case of a closed magnetic path. In the case of a closed magnetic path, unlike the open magnetic path, the lines of magnetic force pass only through the open magnetic path, such that it does not include any “boundary surfaces perpendicular to the lines of magnetic force, that are, boundary surfaces NP^{⊥} and SP^{⊥} perpendicular to the lines of magnetic force illustrated in FIG. 10”.

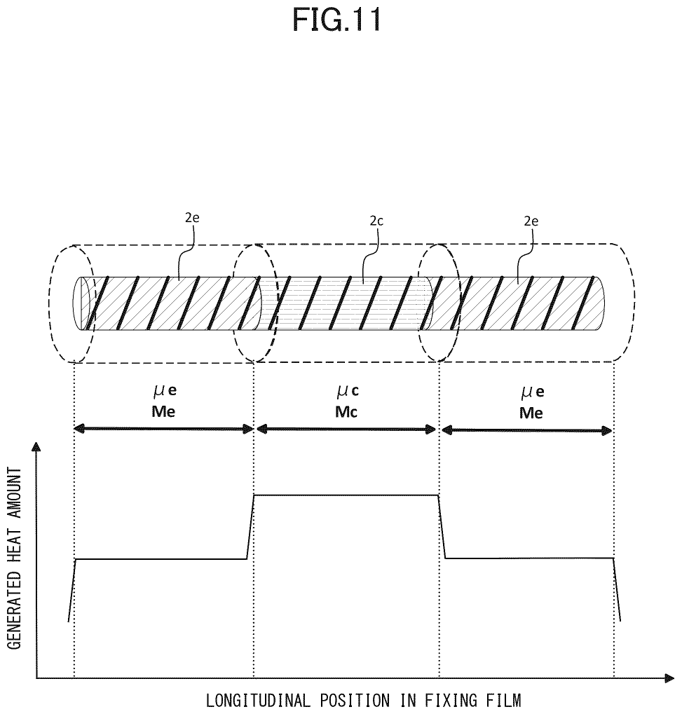

In general, the relationship between mutual inductance M and magnetic permeability is M∝μ, and as described above, the apparent magnetic permeability μ in the magnetic core 2 has a distribution in the longitudinal direction as illustrated in FIG. 9. That is, a combined impedance |X|, in other words, the load resistance of the fixing film 1, also has a distribution in the longitudinal direction. FIG. 11 illustrates one example of a generated heat distribution of the magnetic core 2 in the longitudinal direction. In this drawing, for sake of description, the magnetic core 2 is divided into three parts in the longitudinal direction, and it is assumed that the end portion areas and the center portion area have mutually different magnetic permeabilities. It is also assumed that the magnetic permeability within each area is uniform. When assuming that the apparent magnetic permeability and the mutual inductance are each μe and Me in the end portion magnetic core 2e and μc and Mc in the center portion magnetic core 2c, based on equation (2), the combined impedance Xe and Xc of each area will be as expressed in the following equations (4) and (5).

Equation (4)

$$\vert {X}_{e} \vert = \frac{1}{\sqrt{{( \frac{1}{{R}^{′}} )}^{2} + {( \frac{1}{ω {M}_{e}} )}^{2}}} \qquad ( 4 )$$

$$\vert {X}_{c} \vert = \frac{1}{\sqrt{{( \frac{1}{{R}^{′}} )}^{2} + {( \frac{1}{ω {M}_{c}} )}^{2}}} \qquad ( 5 )$$

Equation (5)

According to equation (4) and equation (5), the combined impedances Xe and Xc of each area respectively have a frequency dependency of (1/ωMₑ)² and (1/ωM_{c})². That is, in the areas having different apparent magnetic permeabilities, the combined impedances have different frequency characteristics.

In fact, based on the above-described assumption, the fixing film 1 shows a generated heat distribution as illustrated in FIG. 11, wherein the center portion is high and the end portions are low. Since the magnitude of magnetic permeability μ is μc>μe, as described above, the mutual inductances satisfy a relationship of Mc>Me, and the combined impedances satisfy a relationship of Xc>Xe. The combined impedance may be assumed as the load resistance of the fixing film, and the magnitude relationship of generated heat amounts in a resistance follows the magnitude relationship of resistance values, such that the center portion generates more heat than the end portions.

Further, in order to facilitate description, in FIG. 11, it is assumed that the apparent magnetic permeability within each of the separated areas is equal, such that the generated heat distribution is also illustrated in a distributive manner, but actually, the apparent magnetic permeability is varied continuously from the center to the end portions, such that the generated heat distribution varies in the same manner.

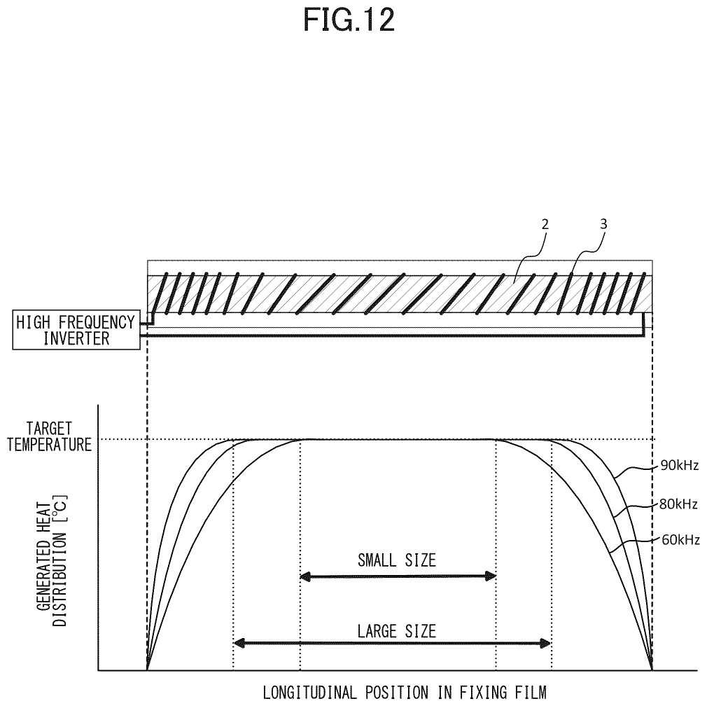

As described, based on equation (4) and equation (5), the load resistance of the fixing film 1 has a frequency characteristic that varies from the center portion toward the end portion of the magnetic core 2. Therefore, the load resistance in each area may be changed by varying the drive frequency, and the generated heat distribution may be controlled. Further according to the present embodiment, as illustrated in FIG. 12, a configuration is adopted in which the exciting coil 3 is wound around the magnetic core 2 in a dense manner at the end portions and in a sparse manner at the center portion. By varying the density in which the exciting coil 3 is wound around the magnetic core 2 in the longitudinal direction as described above, the apparent magnetic permeability may be varied in the different portions, and the balance of generated heat amount of the rotary member 1 in the longitudinal direction of the magnetic core 2 may be adjusted. As a result, according to the present embodiment, the generated heat distribution may be varied according to frequency in the manner illustrated in FIG. 12.

According further to the present embodiment, by taking advantage of the above-mentioned characteristic of “controlling the generated heat distribution by drive frequency”, the control portion 300 changes the drive frequency according to the size of the recording material P or the temperature of a non-sheet passing area of the rotary member 1. The non-sheet passing area refers to the area where a recording material of a maximum size that can be adopted in the apparatus passes but where a recording material having a size smaller than the maximum size does not pass. When subjecting a recording material having a large size to the fixing process, control is performed to heat the entire area in the longitudinal direction of the rotary member 1 uniformly, whereas when subjecting a recording material having a small size to the fixing process, control is performed to suppress the temperature at the end portions of the fixing film 1 by lowering the drive frequency. Thereby, when fixing the recording material having a small size, the rising of temperature of the non-sheet passing area may be suppressed to cut down power consumption.

### Temperature Rising Process of Fixing Film

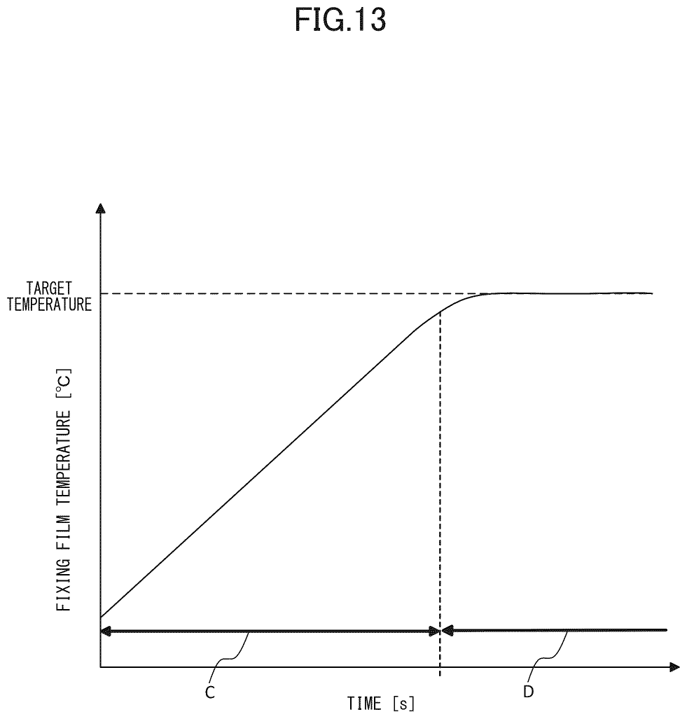

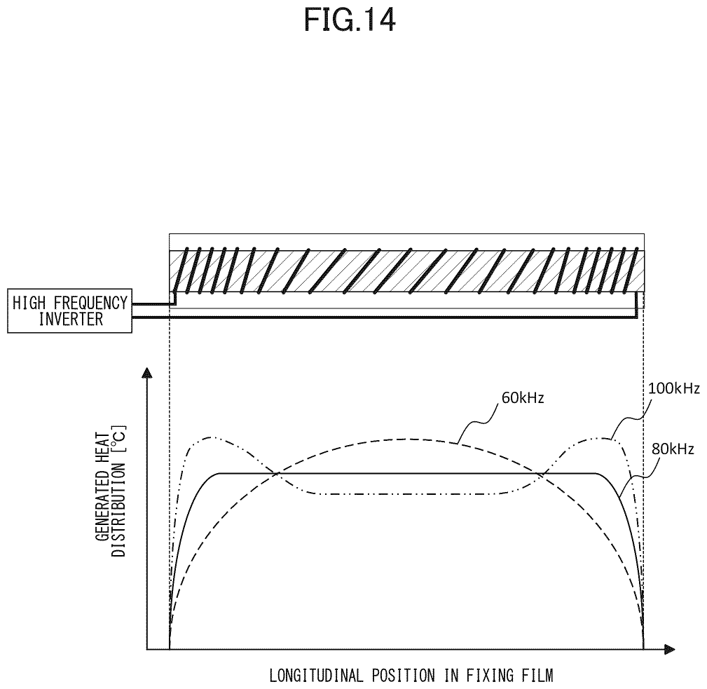

Next, a temperature rising process of the fixing film 1 will be described with reference to FIGS. 13 and 14. FIG. 13 illustrates a schematic view of temperature transition of the fixing film 1 until the fixing film 1 is maintained at a constant temperature based on temperature control. In the drawing, section C is a section in which the fixing film 1 generates heat by the high frequency inverter 16 supplying a maximum power that may be output during a normal state, in which supply of a constant power is continued until the detected temperature of the temperature detecting element 9 based on which temperature control is performed reaches a predetermined value. Section D is a section in which power from the high frequency inverter 16 is appropriately adjusted and supplied such that the detected temperature of the temperature detecting element 9 is constantly maintained to a predetermined value.

FIG. 14 illustrates a generated heat distribution in the longitudinal direction of the fixing film 1 at a certain time in section C of FIG. 13. In section C, power adjustment is not yet performed since the detected temperature of the temperature detecting element 9 has not reached the target temperature, and the supplied power from the high frequency inverter 16 is constant. Therefore, at a certain period of time in section C, the end portions or the center portion of the fixing film 1 will be set to different temperatures according to the drive frequency. In the above description, the temperature of the fixing film 1 has been described, but similarly, the detected temperature of the temperature detecting element 9 will also show a similar characteristics following the temperature transition of the fixing film 1.

### Control of High Frequency Inverter

Next, a control configuration of the high frequency inverter 16 will be described with reference to FIG. 4. FIG. 4 is a control circuit block diagram of the high frequency inverter 16 according to the present embodiment. In FIG. 4, for better understanding, the temperature detecting element 9 is illustrated outside the rotary member 1, similar to FIG. 3.

According to the present embodiment, as illustrated in FIG. 4, the control portion 300 is composed of a computing unit such as a CPU, and a CPU control program is stored in a storage portion, i.e., storage, 23. By performing operation based on the program stored in the storage portion 23, the control portion 300 may function as a power controller 17, a frequency controller 18, a fixing temperature controller 19, a detected result comparison unit 20, an engine controller 21, and a reference value correcting unit 22.

The power controller 17 controls the power that the high frequency inverter 16 supplies to the exciting coil 3, and for example, it outputs a control signal such as a PWM signal to the high frequency inverter 16. Further, the frequency controller 18 changes the drive frequency of the high frequency inverter 16. The fixing temperature controller 19 is connected to the temperature detecting element 9, and supplies temperature information to the engine controller 21 based on a detection result of the temperature detecting element 9. The engine controller 21 is designed to receive input of a print job information and to receive input of the temperature information from the fixing temperature controller 19. Further, the engine controller 21 calculates the power to be supplied from the high frequency inverter 16 to the exciting coil 3 based on the print job information and the temperature information, and enters the calculated value to the power controller 17. Furthermore, the engine controller 21 enters the print job information and the temperature information to the frequency controller 18 so as to enable the frequency controller 18 to change, or set, the drive frequency to an appropriate drive frequency.

According to the present embodiment, by having a high frequency current supplied to the exciting coil 3 from the high frequency inverter 16 via the power controller 17, the surface temperature of the fixing film 1 is adjusted and maintained at the predetermined target temperature, which is approximately 150 to 200° C. Further, based on the size of the recording material P or the temperature of the non-sheet passing area of the rotary member 1, an appropriate drive frequency information is supplied from the frequency controller 18 to the high frequency inverter 16. Thereby, the frequency of the high frequency current supplied to the exciting coil 3 from the high frequency inverter 16 is varied, and the generated heat distribution in the longitudinal direction of the fixing film 1 is changed.

As illustrated in FIG. 14, according to the present embodiment, if the drive frequency of the temperature detecting element 9 arranged at a center portion in the longitudinal direction of the fixing film 1 is high, the detected temperature drops. Meanwhile, it may be possible that the detected temperature of the temperature detecting element 9 drops regardless of the drive frequency, such as due to a failure of the temperature detecting element itself or a poor contact with the fixing film 1. In this case, it may be difficult to determine whether the drop of detected temperature of the temperature detecting element 9 is a normal result caused by the variation of the drive frequency according to the specification of the present embodiment, or is an abnormal result such as failure or poor contact of the temperature detecting element 9. If it is not possible to determine whether the detected temperature of the temperature detecting element 9 is normal or abnormal, it may not be possible to perform error detection or appropriate temperature control. According to the present embodiment, the temperature detecting element 9 is disposed at the center portion in the longitudinal direction of the fixing film 1, but if the temperature detecting element is arranged at the end portion, the detected temperature will drop as illustrated in FIG. 14 when the drive frequency is lowered, such that it may similarly be difficult to determine whether the detection result is normal or abnormal.

The detected result comparison unit 20 determines whether the variation of detected temperature of the temperature detecting element 9 described above is caused by failure of the temperature detecting element 9. Specifically, the temperature information detected by the temperature detecting element 9 is also entered to the detected result comparison unit 20, and when the detected temperature of the temperature detecting element 9 falls below the reference value stored in the storage portion 23, the detected result comparison unit 20 determines that abnormality has occurred. Further, the detected result comparison unit 20 sends an abnormality detection signal to the engine controller 21 when abnormality of the temperature detecting element 9 has been detected. When the abnormality detection signal is received, the engine controller 21 prohibits power supply to the exciting coil 3 and to stop the temperature rising operation of the fixing film 1.

The storage portion 23 stores a reference value S of temperature inclination for determining whether the detected temperature of the temperature detecting element 9 is normal or abnormal, as described above. The reference value correcting unit 22 corrects the reference value S according to a frequency information from the frequency controller 18. Specifically, the reference value correcting unit 22 receives a drive frequency information from the frequency controller 18, and multiples the reference value by a correction coefficient set in advance according to the drive frequency to perform correction.

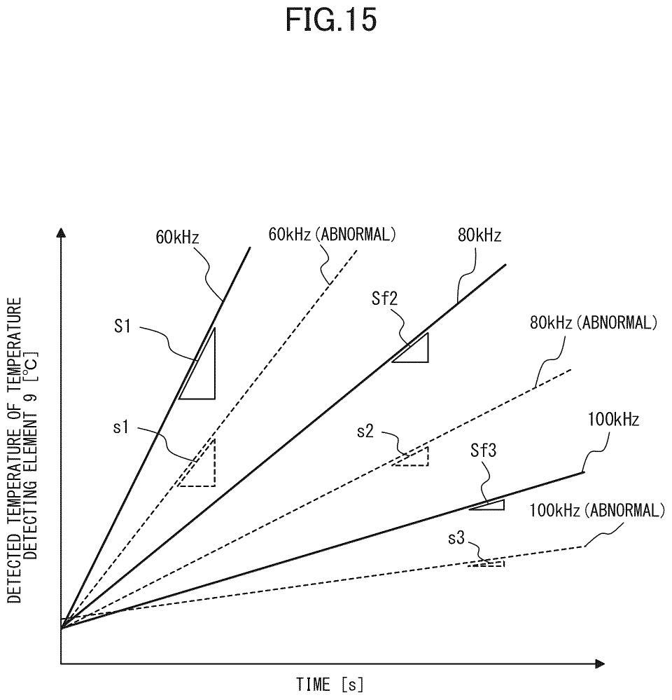

For example, FIG. 15 illustrates a detected temperature transition of the temperature detecting element 9 according to drive frequency in section C (refer to FIG. 13). In FIG. 15, a temperature inclination S1 at 60 kHz is set as the reference value S, and reference values at 80 kHz and 100 kHz that have been corrected in advance based on the following equation (6) and the correction coefficient illustrated in Table 1 are referred to as Sf2 and Sf3.

Equation 6

S_{f}=S×α (6)
S: Reference value
Sₜ: Reference value after correction
α: Correction coefficient

TABLE 1

| Drive Frequency f [kHz] | 60 | 70 | 80 | 90 | 100 |
|---|---|---|---|---|---|
| Correction Coefficient α | 1.0 | 0.8 | 0.6 | 0.4 | 0.2 |

Further, in FIGS. 15, s1, s2, and s3 respectively denote detected temperature inclinations when driven at 60 kHz, 80 kHz, and 100 kHz at a certain time within section C. The reference value S1, the reference values Sf2 and Sf3 corrected based on frequency information, and the detected temperature inclinations s1, s2, and s3 of the respective drive frequencies are respectively compared. If the inclination falls below the reference value as shown by the broken line of FIG. 15 (S>s), the detected result comparison unit 20 determines that abnormality has occurred, and the temperature rising operation of the fixing film 1 is stopped. In this manner, even if the drive frequency is varied, erroneous operation or temperature control failure due to abnormal drop of detected temperature of the temperature detecting element 9 may be prevented. In other words, for example, when 60 kHz is referred to as a first drive frequency and the reference value S1 described above is referred to as a first value, the detected result comparison unit 20 stops heating of the fixing film 1 if the detected temperature inclination s1 is smaller than the first value. Further, when 100 kHz is referred to as a second drive frequency higher than the first drive frequency and the reference value Sf3 described above is referred to as a second value, the detected result comparison unit 20 stops heating of the fixing film 1 if the detected temperature inclination s3 is smaller than the second value. Since the temperature detecting element 9 is a temperature detecting portion that detects temperature of the fixing film 1 at the center portion in the longitudinal direction of the fixing film 1, the second value will be smaller than the first value.

The temperature inclination used as the reference value S may be other than the temperature inclination at 60 kHz. When a plurality of temperature detecting elements are used, the variation of generated heat distribution according to the drive frequency differs according to the location of each temperature detecting element. Therefore, a correction coefficient α of the reference value S according to the drive frequency described above is not necessary the value illustrated in Table 1, and it must be set individually for each temperature detecting element.

For example, if each temperature detecting element detects the temperature of the end portion, the temperature of the end portion of the fixing film 1 as described above is easily raised by higher drive frequency f. Therefore, in this case, regarding the correction coefficient α, the correction efficient of a case where the drive frequency is a second frequency that is lower than the first frequency is smaller than the correction coefficient of a case where the drive frequency is the first frequency. For example, similar to the example of the temperature detecting element 9 described above, in a case where the 60 kHz, which is one example of a first drive frequency, is the drive frequency for setting the reference value, and the reference value of this case is set as a third value, a fourth value which is a reference value corrected for 100 kHz, which is one example of a second drive frequency higher than the first drive frequency, will be greater than the third value. In the case where the drive frequency is a first drive frequency, the detected result comparison unit 20 stops heating of the fixing film 1 if the inclination of the detected temperature is smaller than the third value, and in the case where the drive frequency is a second frequency, the detected result comparison unit 20 stops heating of the fixing film 1 if the inclination of the detected temperature is smaller than the fourth value.

### Abnormality Detection Control of Temperature Detecting Element

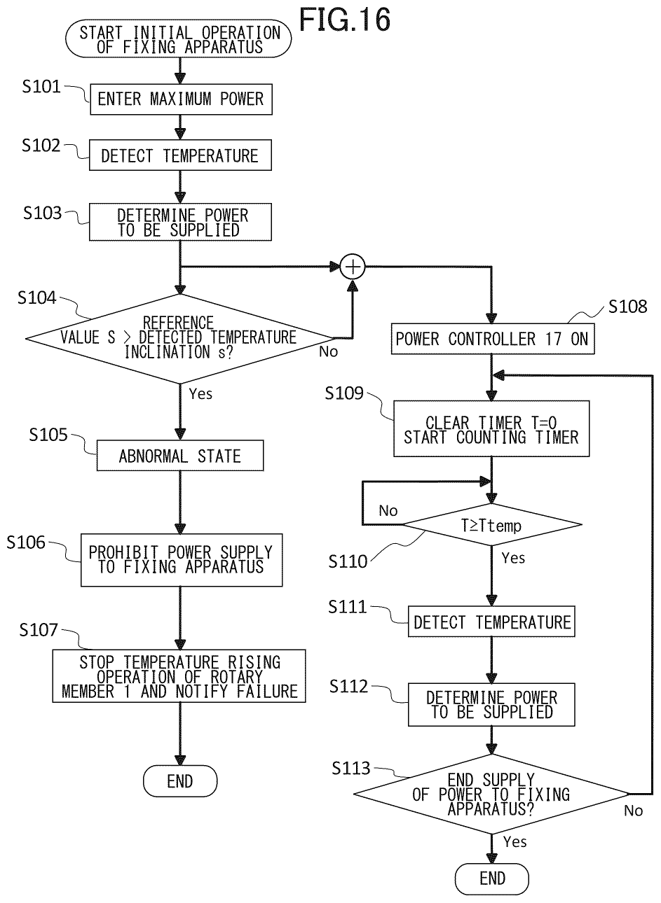

Next, based on the flowchart of FIG. 16, an operation of abnormality detection control of the temperature detecting element 9 described above will be described together with the driving sequence of the fixing apparatus 200. The control processing illustrated in the flowchart is executed based on a program stored in advance in the storage portion 23.

When a print job is entered to the image forming apparatus 100, the control portion 300 controls the high frequency inverter 16 to supply a maximum power that may be supplied during a normal state to the exciting coil 3 so as to raise the temperature of the fixing film 1 to the target temperature (step S101 of FIG. 16). Next, the control portion 300 detects the current temperature of the fixing film 1 based on the detection result of the temperature detecting element 9 (step S102), and based on the difference between the target temperature and the current temperature, determines a supplied power to be supplied to the exciting coil 3 after the supplying of maximum power (step S103).

In this state, the control portion 300 compares the detected temperature inclination s of the temperature detecting element 9 acquired at the time of temperature detection of the above-mentioned step S102 with the temperature inclination reference value S (step S104). In this state, the control portion 300 detects the drive frequency of the high frequency inverter 16, and if there is a need for correction, the reference value Sf corrected as above is used as the temperature inclination reference value.

If the detected temperature inclination s of the temperature detecting element 9 falls below the temperature inclination reference value S (S>s, step S104: Yes), the control portion 300 determines that there is an abnormality in the output of the temperature detecting element 9 (S105).

If it is determined that there is an abnormality in the output of the temperature detecting element 9, the control portion 300 prohibits supplying of power to the fixing apparatus 200 (step S106). Further, the control portion 300 stops the temperature rising operation of the fixing film 1, notifies the occurrence of failure via an operation panel (not shown), and ends the control (step S107).

Meanwhile, if the detected temperature inclination s of the temperature detecting element 9 is equal to the temperature inclination reference value S or greater (S≤s, step S 104: No), it is determined that the output of the temperature detecting element is normal, and the temperature rising operation of the rotary member 1 is continued.

Thereafter, when the temperature of the rotary member 1 approaches the target temperature, the control portion 300 starts to perform control of supplied power so as to suppress the supplied power (step S108). Specifically, the high frequency inverter 16 is controlled so that the supplied power is set to the supplied power determined in step S103.

At the same time, the control portion 300 clears a timer T to 0, starts counting of the timer (step S109), and waits for the elapse of time of timing Ttemp for detecting the current temperature for determining the subsequent power (step S110).

After the elapse of Ttemp, the control portion 300 redetermines the next power to be supplied based on the detected temperature information (step S111 to step S112), and resets the supplied power from the high frequency inverter 16 to the exciting coil 3.

When the supplied power is set again as described above, the control portion 300 determines whether to end the supplying of power (step S113), and if the supplying of power is to be continued (step S113: No), the operation of steps S109 to S113 is repeatedly performed. When the ending of power supply is determined in step S113, the control portion 300 ends the above-described control. In step S113, if a print job is ended, or if the supplying of fixing power is prohibited due to emergency stop operation causes such as sheet jamming or error, the control portion 300 determines to end the power supply.

### Damage Detection of Fixing Film

In a state where a damage such as a crack occurs to the rotary member 1 and conduction of the heat generating pattern of the heat generating layer 1a (FIG. 3) is interrupted, circumferential current will no longer flow through the heat generating pattern, such that the area where damage has occurred and the circumference thereof in the rotary member 1 will not generate heat. In a case where the temperature detecting element 9 is located in such area where heat is no longer generated, the temperature detecting element 9 itself will detect low temperature, such that the engine controller 21 (FIG. 4) performs control to increase the power to be supplied to maintain the target temperature. However, the area other than the detection area of the temperature detecting element 9 generates heat in a normal manner, such that by increasing the supplied power, the temperature rises, and there is a risk that the temperature reaches an abnormal temperature. Therefore, if the heat generating pattern in the detection area of the temperature detecting element 9 in the rotary member 1 is damaged, such damage must be detected to stop the operation.

In contrast, when focusing on the detected temperature of the temperature detecting element 9 in a case where the detection area is damaged and heat is no longer generated, even if the temperature detecting element 9 is operating normally, the temperature detected thereby will be lower compared to the normal state. That is, the above-described method of comparing the detected temperature inclination s of the temperature detecting element 9 and the temperature inclination reference value S corrected based on the frequency information, and determining abnormality to stop operation when the inclination falls below the reference value, may be adopted in a similar manner.

As described above, according to the present embodiment, the abnormality in temperature detection of the fixing film 1 caused by the failure of the temperature detecting element 9 or the damaging of the fixing film may be detected appropriately by focusing on the detected temperature inclination of the temperature detecting element 9, which is the variation amount per unit time of detected temperature of the temperature detecting element 9. That is, according to the present embodiment, the detected temperature inclination of the temperature detecting element 9 and the reference value stored in the storage portion 23 are compared, and if the detected temperature inclination is smaller than the reference value, it is determined that the abnormality in temperature detection of the fixing film 1 has occurred.

Further, in consideration of the state that the generated heat distribution of the fixing film 1 varies according to the setting of drive frequency of the high frequency inverter 16, the present technique corrects the above-described reference value based on the drive frequency information. Therefore, the abnormality in temperature detection of the fixing film 1 may be detected highly accurately. Further, since the abnormality in temperature detection of the fixing film 1 may be detected based on the temperature variation of the temperature detecting element 9, appropriate processing may be performed in response to the abnormality in temperature detection of the fixing film 1, such as by stopping heating control of the fixing film 1. It may also be possible to store the reference value after correction described above in advance in the storage portion.

### Second Embodiment

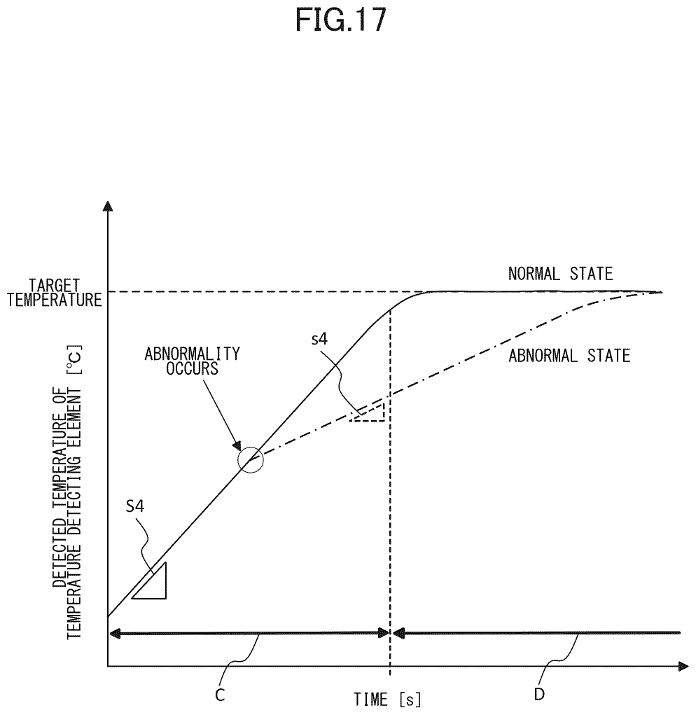

Next, a second embodiment will be described with reference to FIG. 17. In the first embodiment, an example was described of a case where the temperature inclination reference value is stored in advance in the storage portion, whereas the present embodiment differs from the first embodiment in that a temperature inclination of a rotary member during temperature rise is used as the reference value. Therefore, in the following description, only the configurations that differ from the first embodiment are described, and the other configurations are denoted with the same reference numbers and descriptions thereof are not omitted.

FIG. 17 is a schematic view of detected temperature transition of the temperature detecting element 9 until the fixing film 1 is maintained at constant temperature by temperature control. In this embodiment, if abnormality occurs to the temperature detecting element 9, or on a same circumference as the detection area of the temperature detecting element 9 in the fixing film 1, during temperature rise of the fixing film 1, the detected temperature of the temperature detecting element 9 will be as illustrated by the broken line in the drawing.

During such abnormality, the time of section C during which a maximum power of the high frequency inverter 16 is constantly supplied elongates compared to a normal state, such that excessive temperature rise may occur. Therefore, according to the present embodiment, the control portion 300 stores a detected temperature inclination S4 of the temperature detecting element 9 immediately after starting of temperature rise in the storage portion 23 (FIG. 4) as the temperature inclination reference value S. Then, similar to the first embodiment, in the reference value correcting unit 22, the reference value S is corrected based on the information of drive frequency of the high frequency inverter 16, and the corrected value is compared with a temperature inclination s4 at the end of section C.

In a case where the temperature inclination s4 is smaller than the detected temperature inclination S4 that has been corrected as the reference value (S4>s4), the control portion 300 determines that abnormality has occurred, and stops the temperature rising operation of the fixing film 1.

Thereby, even if abnormality occurs to the detected temperature of the temperature detecting element 9 during temperature rise of the fixing film 1, it may be possible to detect such abnormality and to prevent erroneous operation or excessive temperature rise. Further, by correcting the reference value S based on frequency information, even if the frequency and the generated heat distribution of the rotary member 1 is varied by failure during temperature rise of the fixing film 1, abnormality may be detected by the present embodiment, similar to the first embodiment.

As described above, according to the present embodiment, a variation amount per unit time of detected temperature of the temperature detecting element 9 in a first period, such as section C described above, is stored as a reference value of detected temperature inclination in a storage 23. Therefore, even if the reference value of detected temperature inclination is not stored in advance in the storage portion 23, the abnormality in temperature detection of the fixing film 1 in a second period after the first period may be detected.

### Third Embodiment

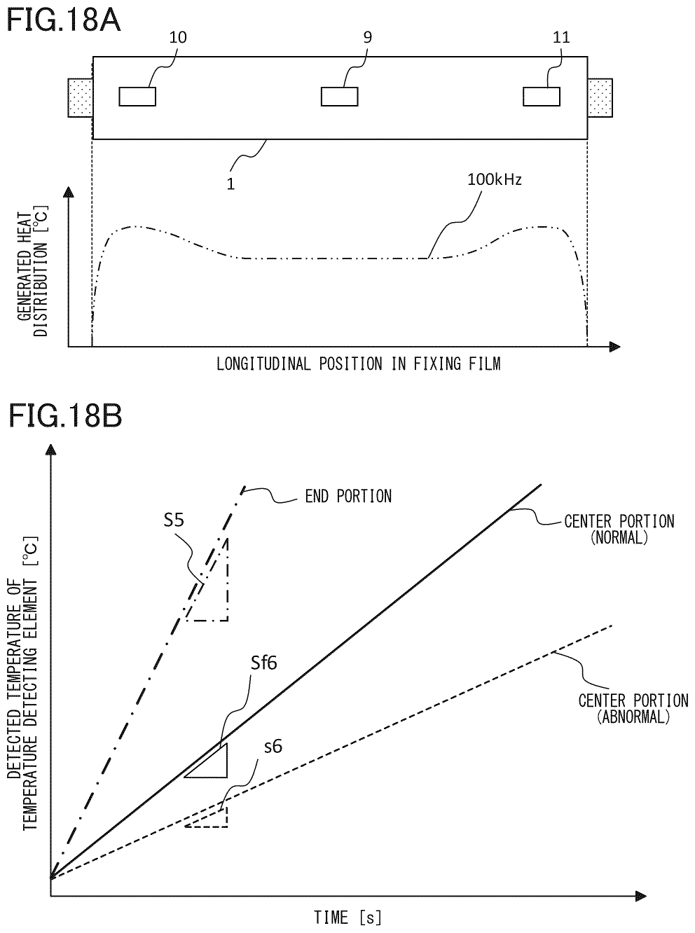

Next, a third embodiment will be described with reference to FIG. 18. The present embodiment differs from the first embodiment in that abnormality detection is performed using a plurality of temperature detecting elements. Therefore, in the following description, only the configurations that differ from the first embodiment are illustrated, and the other configurations are denoted with the same reference numbers and descriptions thereof are omitted.

As illustrated in FIG. 18A, the fixing apparatus 200 according to the present embodiment includes the temperature detecting element 9 that detects temperature at a center portion in the longitudinal direction of the fixing film 1, and temperature detecting elements 10 and 11 that detect the temperature at end portions in the longitudinal direction of the fixing film 1.

FIG. 18B is a graph illustrating a transition of detected temperature in section C of the temperature detecting element 9 arranged at the center portion in the longitudinal direction of the fixing film 1 described above and a temperature detecting element 10 arranged at an end portion in the longitudinal direction of the fixing film 1.

In the present embodiment, the control portion 300 stores a detected temperature inclination S5 of the temperature detecting element 10 arranged at an end portion as the temperature inclination reference value S in the storage portion 23. Since a temperature difference occurs between the center portion and the end portion of the fixing film 1 due to drive frequency of a high frequency inverter 61, the control portion 300 corrects the temperature inclination reference value S based on an information on a correlation between detected temperatures of the temperature detecting element 9 and the temperature detecting element 10 and on a frequency information of drive frequency. In the following description, the temperature inclination reference value regarding the temperature detecting element 9 at the center portion that has been obtained by correcting the detected temperature inclination S5 of the temperature detecting element 10 at the end portion is referred to as Sf6.

Next, the control portion 300 compares a detected temperature inclination s6 of the temperature detecting element 9 arranged at the center portion with the temperature inclination reference value Sf6 described above, and if the detected temperature inclination s6 falls below the temperature inclination reference value Sf6 (Sf6>s6), it is determined that abnormality has occurred.

In the above-described manner, the detected temperature inclinations of temperature detecting elements that are arranged at locations having different generated heat amounts may be compared, based on which the abnormality of the detected temperature of one of the temperature detecting elements may be detected to stop the temperature rising operation of the fixing film 1.

As described, according to the present embodiment, the fixing apparatus 200 includes at least a first temperature detecting portion 9 that detects the temperature of the fixing film 1 at a first position in the longitudinal direction and a second temperature detecting portion 10 that detects the temperature of the fixing film 1 at a second position that differs from the first position in the longitudinal direction. Further, the storage portion 23 stores a reference value of a variation amount per unit time of detected temperature detected by the second temperature detecting portion 10 as the reference value. The control portion 300 corrects the above-described reference value based on the information related to correlation of detected temperatures of the first temperature detecting portion 9 and the second temperature detecting portion 10 and the drive frequency information. Thereby, it becomes possible to detect the abnormality in temperature detection regarding the detected temperature of the fixing film 1 in the first temperature detecting portion 9 using the reference value of the variation amount per unit time of the detected temperature detected by the second temperature detecting portion 10.

In other words, in a state where the drive frequency of the inverter is a first drive frequency, if the variation amount per unit time of the detected temperature of the first temperature detecting portion is smaller than a fifth value according to the first drive frequency, or if the variation amount per unit time of the detected temperature of the second temperature detecting portion 10 is smaller than a sixth value obtained based on the fifth value and the information related to the above-described correlation, the heating of the fixing film 1 is stopped. It is also possible to state that if the drive frequency of the inverter is a second drive frequency that differs from the first drive frequency, if the variation amount per unit time of the detected temperature of the first temperature detecting portion is smaller than a seventh value according to a second drive frequency, or if the variation amount per unit time of the detected temperature of the second temperature detecting portion is smaller than an eighth value obtained based on the seventh value and the information related to the above-described correlation, the heating of the rotary member is stopped.

According to the embodiment described above, the detected temperature inclination S5 of the temperature detecting element 10 at the end portion is corrected to obtain the temperature inclination reference value of the temperature detecting element 9 at the center portion, but the present technique is not limited thereto. For example, the temperature inclination reference value of the temperature detecting element 9 at the center portion may be obtained by correcting the detected temperature inclination of a temperature detecting element 11 at the end portion. Further, the temperature inclination reference value of the temperature detecting element 10/11 at the end portion may be obtained by correcting the detected temperature inclination of the temperature detecting element 9 at the center portion. In other words, the detected temperature inclination of any temperature detecting element may be used as the temperature inclination reference value S, and the comparison of the reference value and the detected temperature inclination may be performed between any temperature detecting elements. Further, the comparison of the temperature inclination reference value S may be based on detected temperature inclinations of temperature detecting elements located at two or more locations.

### Fourth Embodiment

Next, a fourth embodiment will be described. In the following description, only the configurations that differ from the first embodiment are illustrated, and the other configurations are denoted with the same reference numbers and descriptions thereof are omitted.

In an electromagnetic induction heating type system, the generated heat distribution of the fixing film 1 varies according to drive frequency. Therefore, according to the first to third embodiments described above, an example of correcting the temperature inclination reference value S based on the information of drive frequency of the high frequency inverter 16 for detecting abnormal output of the temperature detecting element has been described. Meanwhile, there are some parameters other than the drive frequency mentioned above that may serve as the parameter that varies the generated heat distribution in the electromagnetic induction heating type system. Such parameters are described below.

Power Supplied from High Frequency Inverter 16 to Exciting Coil 3

In the electromagnetic induction heating type system, the generated heat amount of the fixing film 1 varies according to the magnitude of power supplied from the high frequency inverter 16 to the exciting coil 3. Since the temperature detecting element monitors the temperature of the fixing film 1, when the generated heat amount of the fixing film 1 varies, the detected temperature of the temperature detecting element 9, or 10, or 11, is varied along therewith.

### Rotational Speed of Fixing Film

In a state where the pressing roller 8 is driven to rotate in a state where the fixing film 1 is in pressure contact with the pressing roller 8, the fixing film 1 rotates while forming a nip portion N. Since the thickness of the fixing film 1 is thin, a thermal capacity of the fixing film 1 is small, and the fixing film 1 rotates while being in contact with the pressing roller 8 having a large thermal capacity, the heat quantity of the fixing film 1 is continuously taken by the pressing roller 8 via the nip portion N.

Further according to the electromagnetic induction heating type system, since the entire circumference of the fixing film 1 generates heat, temperature continues to rise without having heat taken therefrom, except for the nip portion. In other words, when focusing on an arbitrary surface of the fixing film 1, temperature continues to rise by the generation of heat at the entire circumference, and each time the surface enters the nip portion N by rotation, the heat quantity is taken therefrom by the pressing roller 8 and the temperature drops.

Therefore, the variation of rotational speed, in other words, the variation of speed in which the fixing film 1 enters the nip portion N, means that the temperature rising speed of the fixing film 1 varies, and along therewith, the detected temperature of the temperature detecting element 9, or 10 or 11, also varies.

### Variation of Resistance Value of Fixing Film

There is a slight variation of resistance value in each one of the heat generating patterns of the heat generating layer 1a in the fixing film 1. This is caused by the dispersion of width and thickness that occurs when forming the heat generating layer 1a of the fixing film 1, which cannot be avoided due to the manufacturing process. Focusing on equation (4) and equation (5) related to the combined impedance X derived in the first embodiment, these equations contain a term including a resistance value R of the fixing film 1.

This means that if the resistance value of the fixing film 1 varies, the combined impedance X is also varied along therewith. Since the combined impedance X has various frequency characteristics in the respective areas in the longitudinal direction of the magnetic core 2 due to the difference of apparent magnetic permeability, when the resistance value of the fixing film 1 varies, the combined impedances X will also vary in each area. Therefore, if the resistance value of the fixing film 1 is dispersed, even if the fixing film is operated based on the same power and same drive frequency, the generated heat distribution in the longitudinal distribution differs for each fixing film 1, which leads to the variation of detected temperature of the temperature detecting element.

In the present embodiment, the reference value correcting unit 22 corrects the temperature inclination reference value S using at least one of the following parameters of supplied power information, rotational speed information of the fixing film 1, and dispersion of resistance value of the fixing film 1, in addition to the drive frequency. Thereby, it becomes possible to further enhance the detection accuracy of abnormal output of the temperature detecting element 9. The techniques of the above-mentioned embodiments may be combined in any way.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-155380, filed Sep. 9, 2024, which is hereby incorporated by reference herein in its entirety.

What is claimed is:

1. An image heating apparatus configured to heat an image formed on a recording material, the image heating apparatus comprising:
a tubular rotary member including a conductive layer;
a magnetic core disposed in an interior of the rotary member and configured to form an open magnetic path in a longitudinal direction of the rotary member;
an exciting coil wound around the magnetic core such that a helical axis thereof is arranged along the longitudinal direction;
an inverter configured to flow alternating current in the exciting coil;
a control portion configured to control the inverter to cause alternating current to flow through the exciting coil such that alternating magnetic flux is generated in the magnetic core to heat the rotary member by electromagnetic induction;
at least one temperature detecting portion configured to detect a temperature of the rotary member; and
a storage configured to store a reference value of a variation amount per unit time of a detected temperature detected by the temperature detecting portion,
wherein the control portion is configured to change a driving frequency of the inverter, and
wherein the control portion is configured to:
acquire the variation amount per unit time of the detected temperature detected by the temperature detecting portion;
correct the reference value based on the drive frequency of the inverter at the time when the variation amount is acquired; and
stop heating of the rotary member in a case where the variation amount is smaller than the reference value being corrected.

2. The image heating apparatus according to claim 1,
wherein the control portion is configured to:
store a variation amount per unit time of the detected temperature of the temperature detecting portion in a first period as the reference value in the storage; and
stop heating of the rotary member in a case where a variation amount per unit time of the detected temperature of the temperature detecting portion in a second period after the first period is smaller than the reference value corrected based on the drive frequency.

3. The image heating apparatus according to claim 1,
wherein the at least one temperature detecting portion includes a first temperature detecting portion configured to detect a temperature of the rotary member at a first position in a longitudinal direction of the rotary member and a second temperature detecting portion configured to detect a temperature of the rotary member at a second position that differs from the first position in the longitudinal direction,
wherein the storage is configured to store, as the reference value, a reference value of a variation amount per unit time of a detected temperature detected by a second temperature detecting portion, and
wherein the control portion is configured to:
correct the reference value based on an information regarding correlation of detected temperatures of the first temperature detecting portion and the second temperature detecting portion, and on the drive frequency; and
stop heating of the rotary member in a case where a variation amount per unit time of the detected temperature of the first temperature detecting portion is smaller than the reference value being corrected.

4. The image heating apparatus according to claim 1, wherein the control portion is configured to correct the reference value based on the drive frequency, and at least one of a power being supplied to the exciting coil from the inverter, a rotational speed of the rotary member, and a resistance value of the conductive layer.

5. The image heating apparatus according to claim 1, wherein the control portion is configured to notify occurrence of abnormality in a case where the variation amount is smaller than a reference value being corrected.

6. The image heating apparatus according to claim 1,
wherein the at least one temperature detecting portion includes a temperature detecting portion that detects temperature at a center portion in the longitudinal direction of the rotary member, and
wherein the control portion is configured to:
in a case where a drive frequency of the inverter is a first drive frequency, stop heating of the rotary member in a case where a variation amount per unit time of the detected temperature of the temperature detecting portion that detects temperature at the center portion in the longitudinal direction of the rotary member is smaller than a first value; and
in a case where a drive frequency of the inverter is a second drive frequency that is higher than the first drive frequency, stop heating of the rotary member in a case where a variation amount per unit time of the detected temperature of the temperature detecting portion that detects temperature at the center portion in the longitudinal direction of the rotary member is smaller than a second value that is smaller than the first value.

7. The image heating apparatus according to claim 6,
wherein the at least one temperature detecting portion includes a temperature detecting portion that detects temperature at an end portion in the longitudinal direction of the rotary member, and
wherein the control portion is configured to:
in a case where a drive frequency of the inverter is a first drive frequency, stop heating of the rotary member in a case where a variation amount per unit time of the detected temperature of the temperature detecting portion that detects temperature at the end portion in the longitudinal direction of the rotary member is smaller than a third value; and
in a case where a drive frequency of the inverter is a second drive frequency that is higher than the first drive frequency, stop heating of the rotary member in a case where a variation amount per unit time of the detected temperature of the temperature detecting portion that detects temperature at the end portion in the longitudinal direction of the rotary member is smaller than a fourth value that is greater than the third value.

8. An image heating apparatus configured to heat an image formed on a recording material, the image heating apparatus comprising:
a tubular rotary member including a conductive layer;
a magnetic core disposed in an interior of the rotary member and configured to form an open magnetic path in a longitudinal direction of the rotary member;
an exciting coil wound around the magnetic core such that a helical axis thereof is arranged along the longitudinal direction;
an inverter configured to flow alternating current in the exciting coil;
a control portion configured to control the inverter to cause alternating current to flow through the exciting coil such that alternating magnetic flux is generated in the magnetic core to heat the rotary member by electromagnetic induction; and
a first temperature detecting portion configured to detect a temperature of the rotary member at a center portion in the longitudinal direction of the rotary member,
wherein, when a drive frequency of the inverter is a first drive frequency, the control portion is configured to stop heating of the rotary member in a case where a variation amount per unit time of a detected temperature of the first temperature detecting portion is smaller than a first value; and
wherein, when a drive frequency of the inverter is a second drive frequency that is greater than the first drive frequency, the control portion is configured to stop heating of the rotary member in a case where a variation amount per unit time of the detected temperature of the first temperature detecting portion is smaller than a second value that is smaller than the first value.

9. The image heating apparatus according to claim 8, further comprising
a second temperature detecting portion configured to detect temperature of the rotary member at an end portion in the longitudinal direction of the rotary member,
wherein, when a drive frequency of the inverter is a first drive frequency, the control portion is configured to stop heating of the rotary member in a case where a variation amount per unit time of a detected temperature of the second temperature detecting portion is smaller than a third value; and
wherein, when a drive frequency of the inverter is a second drive frequency, the control portion is configured to stop heating of the rotary member in a case where a variation amount per unit time of the detected temperature of the first temperature detecting portion is smaller than a fourth value that is greater than the third value.

10. The image heating apparatus according to claim 8,
wherein, in a case where a drive frequency of the inverter is a first drive frequency, the control portion is configured to:
set the first value based on a variation amount per unit time of the detected temperature of the first temperature detecting portion in a first period; and
stop heating of the rotary member in a case where a variation amount per unit time of the detected temperature of the first temperature detecting portion in a second period after the first period is smaller than the first value.

11. An image heating apparatus configured to heat an image formed on a recording material, the image heating apparatus comprising:
a tubular rotary member including a conductive layer;
a magnetic core disposed in an interior of the rotary member and configured to form an open magnetic path in a longitudinal direction of the rotary member;
an exciting coil wound around the magnetic core such that a helical axis thereof corresponds to the longitudinal direction;
an inverter configured to flow alternating current in the exciting coil;
a control portion configured to control the inverter to cause alternating current to flow through the exciting coil such that alternating magnetic flux is generated in the magnetic core to heat the rotary member by electromagnetic induction;
a first temperature detecting portion configured to detect a temperature of the rotary member at a first position in the longitudinal direction of the rotary member; and
a second temperature detecting portion configured to detect a temperature of the rotary member at a second position that differs from the first position in the longitudinal direction,
wherein, when a drive frequency of the inverter is a first drive frequency, the control portion is configured to stop heating of the rotary member in a case where a variation amount per unit time of a detected temperature of the first temperature detecting portion is smaller than a fifth value corresponding to the first drive frequency, or in a case where a variation amount per unit time of a detected temperature of the second temperature detecting portion is smaller than a sixth value obtained based on the fifth value and an information related to correlation of the detected temperature of the first temperature detecting portion and the detected temperature of the second temperature detecting portion; and
wherein, when a drive frequency of the inverter is a second drive frequency that differs from the first drive frequency, the control portion is configured to stop heating of the rotary member in a case where a variation amount per unit time of the detected temperature of the first temperature detecting portion is smaller than a seventh value corresponding to the second drive frequency, or in a case where a variation amount per unit time of the detected temperature of the second temperature detecting portion is smaller than an eighth value obtained based on the seventh value and an information related to correlation of the detected temperature of the first temperature detecting portion and the detected temperature of the second temperature detecting portion.

12. An image forming apparatus comprising:
an image forming unit configured to form a toner image on a recording material; and
the image heating apparatus according to claim 1,
wherein the image heating apparatus is a fixing apparatus configured to heat the recording material on which the toner image is formed and fix the toner image onto the recording material.
